(19) United States
(12) Patent Application Publication
(10) Pub. No.: US 2010/0142785 A1
(43) Pub. Date: Jun. 10, 2010

(54) POSITIVE CONTRAST MR SUSCEPTIBILITY IMAGING

(75) Inventors: Hannes Dahnke, Hamburg (DE); Wei Liu, Briarcliff Manor, NY (US); Edward Brian Welch, Highland Heights, OH (US); Tobias Richard Schaeffter, London (GB)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/597,750

(22) PCT Filed: Apr. 30, 2008
(86) PCT No.: PCT/IB08/51672

§ 371 Date: Oct. 27, 2009

Related U.S. Application Data
(60) Provisional application No. 60/914,809, filed on Apr. 30, 2007.

(51) Int. Cl. G06K 9/40; G06K 9/00

(52) U.S. Cl. 382/131

(57) ABSTRACT

A method for generating an image comprises: acquiring a magnetic resonance image (D_{I}); generating a magnetic susceptibility gradient vector map (D_{Δχ}) from the magnetic resonance image; and filtering the magnetic susceptibility gradient vector map to generate a magnetic susceptibility gradient image (96, 110) depicting magnetic susceptibility gradient information including at least some magnetic susceptibility gradient directional information.

The present application relates to the magnetic resonance arts. It is described with particular reference to imaging of features containing an ferrous materials, such as stem cells labeled with an iron oxide-based magnetic contrast agent, anatomical imaging using an iron oxide based magnetic contrast agent, deoxygenated blood imaging, and so forth. However, the following is amenable to other applications relating to imaging incorporating magnetic susceptibility contrast, such as probe imaging during interventional magnetic resonance, detection of in vivo foreign objects, and so forth.

An object or feature having a magnetic susceptibility that deviates from its surrounding creates local inhomogeneity of the main (B₀) magnetic field. In a magnetic resonance image, such local inhomogeneity typically appears as a dark or low contrast region in the magnetic resonance image. Some examples of objects that may appear dark due to this effect in the context of imaging of surrounding human or animal tissue include metallic objects such as surgical instruments, implants or other devices, iron-containing substances like deoxygenated blood, iron oxide based contrast agents, or iron oxide-labeled cells. A metallic device or a gas-filled region has a magnetic susceptibility that differs substantially from surrounding tissue, and hence may appear dark in an image. The exploitation of this effect is an important tool for different MR imaging applications ranging from contrast agent (e.g. SPIO) detection to the localization of interventional devices such as catheters, implantable stents, and so forth.

Susceptibility contrast enhanced magnetic resonance imaging is usually performed using T₂ or T₂* weighted sequences. With these sequences the contrast is created by signal losses at the site of a local magnetic field disturbance, and so the feature causing the susceptibility contrast appears as a dark object. Unfortunately, these dark objects are not readily distinguishable in the image from other image features or artifacts generated by signal losses, or regions with lower proton density.

Several approaches have been proposed for obtaining positive (bright) contrast induced by magnetic susceptibility gradients. For example, EP 1 471 362 A1 discloses a method based on a gradient echo (GE) imaging sequence, in which imbalance of switched magnetic field gradients or additional gradients are applied in order to generate an image showing positive (bright) contrast between background tissue and objects producing local magnetic field inhomogeneities. This approach entails an a priori estimate of the strength of the susceptibility gradients, which is problematic. In one approach, an elaborate and time-consuming optimization procedure is performed to provide the susceptibility gradient strength estimate. Moreover, the use of a special magnetic resonance imaging sequence entails increased imaging time and complexity.

Still further, providing positive (bright) contrast in magnetic susceptibility gradient contrast imaging does not address the difficulty that there may be multiple sources of such contrast. For example, one application of magnetic susceptibility gradient contrast imaging is detection and study of cells or cell aggregations, in which the cells of interest are labeled with an iron oxide-based magnetic contrast agent. Using a positive (bright) magnetic susceptibility contrast imaging technique assures that the labeled cells will appear bright in the image, but does nothing to distinguish the labeled cells from other magnetic susceptibility gradient contrast sources such as air/tissue boundaries.

The following provides improvements, which overcome the above-referenced problems and others.

In accordance with one aspect, a method is disclosed comprising: acquiring magnetic resonance imaging data; generating a magnetic susceptibility gradient vector map from the magnetic resonance imaging data; and filtering the magnetic susceptibility gradient vector map to generate a magnetic susceptibility gradient image depicting magnetic susceptibility gradient information including at least some magnetic susceptibility gradient directional information.

In accordance with another aspect, a processor is disclosed that is programmed to perform a method comprising: acquiring magnetic resonance imaging data; generating a magnetic susceptibility gradient vector map from the magnetic resonance imaging data; and filtering the magnetic susceptibility gradient vector map to generate a magnetic susceptibility gradient image depicting magnetic susceptibility gradient information including at least some magnetic susceptibility gradient directional information.

In accordance with another aspect, an apparatus is disclosed comprising: a magnetic susceptibility gradient processor configured to generate a magnetic susceptibility gradient vector map from magnetic resonance imaging data; and a susceptibility gradient filter configured to filter the magnetic susceptibility gradient vector map to generate a magnetic susceptibility gradient image depicting magnetic susceptibility gradient information including at least some magnetic susceptibility gradient directional information.

In accordance with another aspect, a storage medium is disclosed storing instructions executable to perform a method comprising: generating a magnetic susceptibility gradient vector map from magnetic resonance imaging data; and filtering the magnetic susceptibility gradient vector map to generate a magnetic susceptibility gradient image depicting magnetic susceptibility gradient information including at least some magnetic susceptibility gradient directional information.

One advantage resides in facilitating distinguishing of different sources of magnetic susceptibility gradient contrast.

Another advantage resides in providing improved magnetic susceptibility gradient contrast in magnetic resonance images.

Another advantage resides in providing magnetic susceptibility gradient contrast including at least some susceptibility gradient directional information.

Another advantage resides in improved medical diagnostic, clinical, and related analyses achievable using characterization by magnetic resonance incorporating magnetic susceptibility contrast.

Still further advantages of the present invention will be appreciated to those of ordinary skill in the art upon reading and understand the following detailed description.

The drawings are only for purposes of illustrating the preferred embodiments, and are not to be construed as limiting the invention.

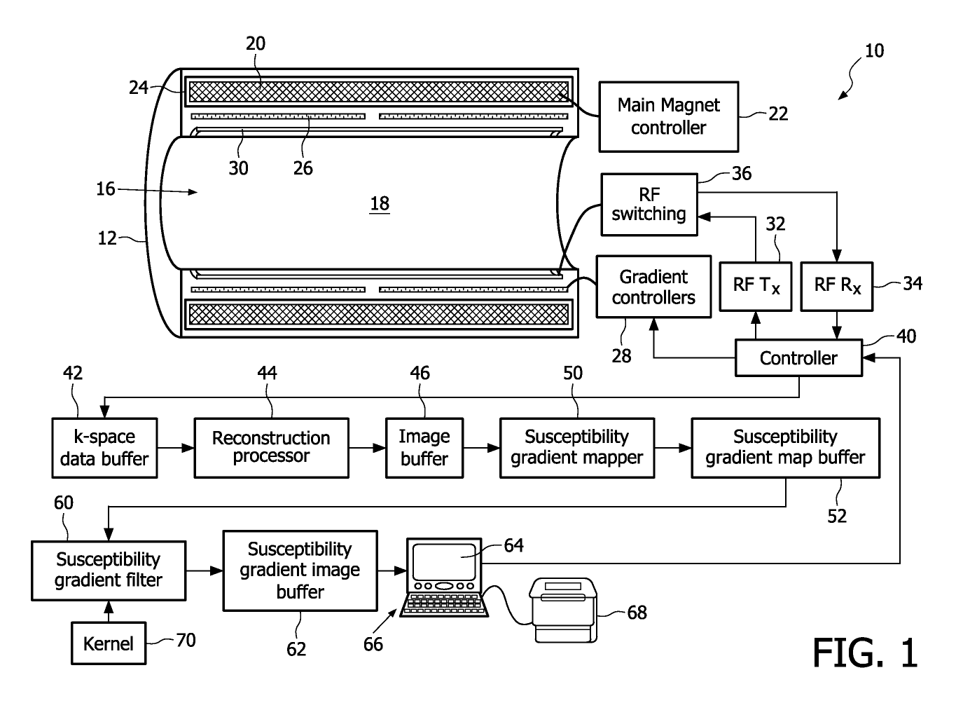

FIG. 1 diagrammatically shows a magnetic resonance system including magnetic susceptibility gradient contrast enhancement elements.

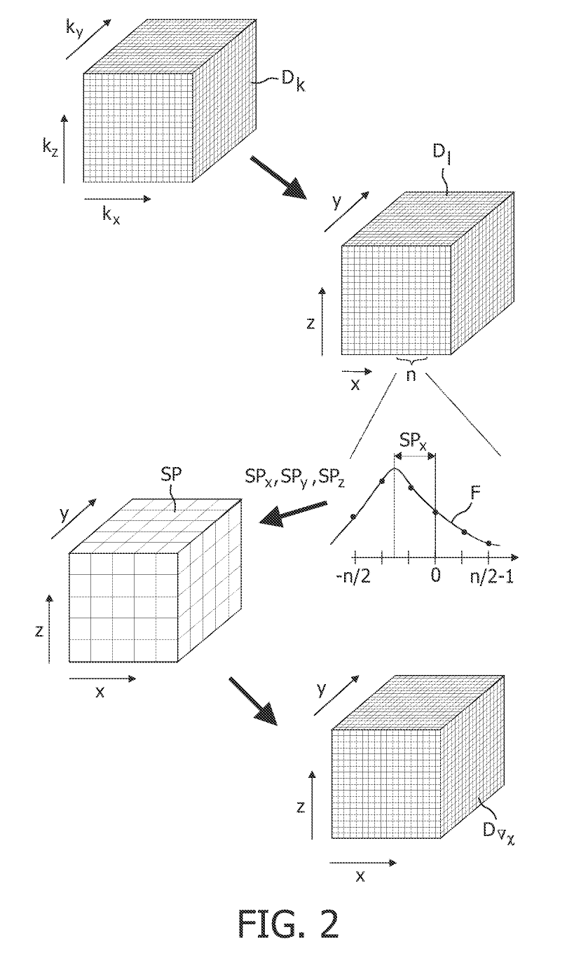

FIG. 2 diagrammatically shows magnetic susceptibility gradient processing performed by an illustrative embodiment of the reconstruction processor and susceptibility gradient mapper components of the system of FIG. 1.

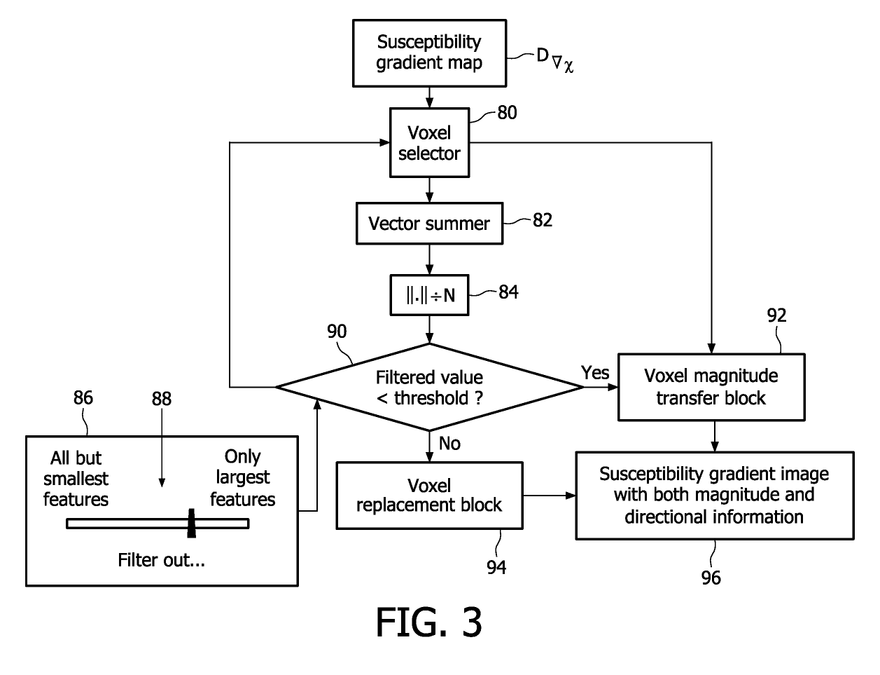

FIG. 3 diagrammatically shows an illustrative embodiment of the susceptibility gradient filter component of FIG. 1.

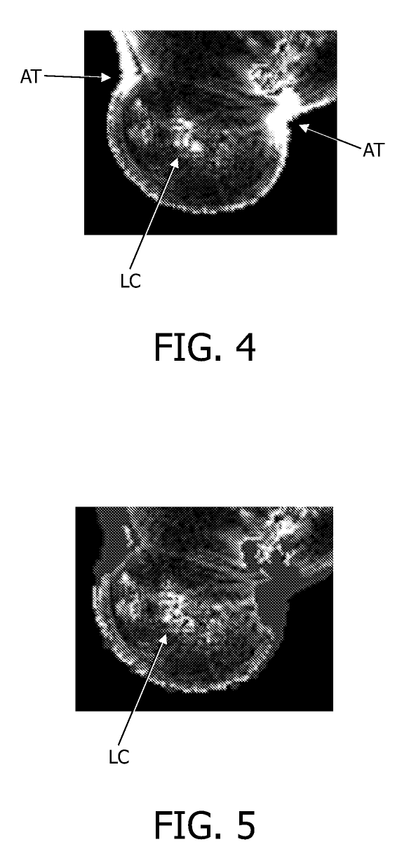

FIG. 4 diagrammatically shows a magnitude image of a susceptibility gradient map without filtering.

FIG. 5 diagrammatically shows a magnitude image of a susceptibility gradient map for the same data as FIG. 4, but with filtering in accordance with the filter embodiment of FIG. 3 to suppress susceptibility gradient features having relatively long-range directional ordering.

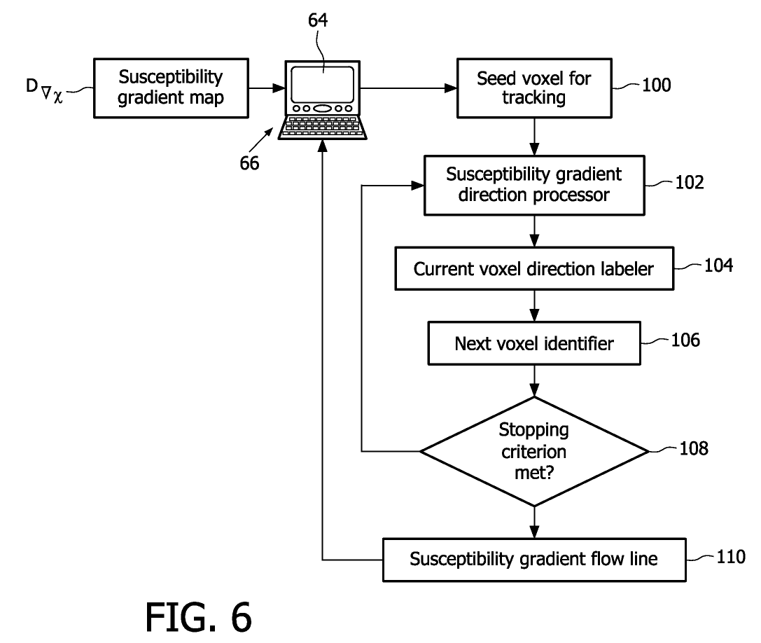

FIG. 6 diagrammatically shows another illustrative embodiment of the susceptibility gradient filter component of FIG. 1.

With reference to FIG. 1, a magnetic resonance scanner 10 includes a scanner housing 12 defining a bore 16 surrounding an examination region 18 into which an imaging subject (not shown) is disposed. The illustrated magnetic resonance scanner 10 is a horizontal bore-type scanner shown diagrammatically in partial cutaway to reveal selected internal components, including a main magnet 20 disposed in the scanner housing 12 and controlled by a main magnet controller 22 to generate a static (B₀) magnetic field in the examination region 18. Typically, the main magnet 20 is a persistent superconducting magnet surrounded by cryoshrouding 24, although a resistive magnet can also be used. In some embodiments, the main magnet 20 generates a main magnetic field of between about 0.23 Tesla and about 7 Tesla; however, main magnetic fields of strengths above or below this typical range are also contemplated. A gradient system including magnetic field gradient coils 26 arranged in or on the housing 12 and corresponding gradient controllers 28 superimpose selected magnetic field gradients on the main magnetic field in at least the examination region 18. Typically, the magnetic field gradient coils 26 include coils for producing three orthogonal magnetic field gradients, such as x-, y-, and z-gradients. Although not shown, additional active coil shims or passive (e.g., ferromagnetic) shims may be included to shim the magnetic field.

A generally cylindrical whole-body coil 30 is optionally mounted substantially coaxially with the bore of the magnetic resonance scanner 10. The whole-body coil 30 may be, for example, a quadrature birdcage coil, transverse electromagnetic (TEM) coil, or so forth. Additionally or alternatively, one or more local radio frequency coils such as a surface coil or plurality of surface coils, a SENSE coil array, a torso coil, or so forth (not shown) can be employed. In the embodiment of FIG. 1, the whole-body coil 30 performs both transmit and receive functions. That is, the whole-body coil 30 is energized at a magnetic resonance frequency by one or more radio frequency transmitters 32 to excite magnetic resonance in a subject disposed in the examination region 18, and the whole-body coil 30 is also used in conjunction with one or more radio frequency receivers 34 to receive magnetic resonance signals emanating from the subject responsive to such excitation. Radio frequency switching circuitry 36 enables the whole-body coil 30 to perform both transmit and receive functions. While shown as a separate unit, in some embodiments the radio frequency switching circuitry or portions thereof may be integrated into the whole-body coil, the radio frequency transmitter, or the radio frequency receiver. In other contemplated embodiments, the whole-body coil 30 performs the transmit function, while one or more local radio frequency coils receives the generated magnetic resonance signals. In other contemplated embodiments, the whole-body coil 30 is omitted and one or more local radio frequency coils perform both transmit and receive functions. It is still further contemplated to use the whole-body coil 30 as a receive coil while magnetic resonance is excited using one or more local radio frequency coils. Other radio frequency coils and coil combinations are also contemplated for performing magnetic resonance excitation and signal detection.

Although a horizontal bore-type scanner is illustrated as an example, it is to be appreciated that substantially any type of magnetic resonance scanner can be used, such as a vertical magnetic resonance scanner, an open magnetic resonance scanner, or so forth.

The magnetic resonance scanner 10 operates under the control of a scanner controller 40 to perform a selected magnetic resonance sequence, such as a three-dimensional echo-planar imaging (3D-EPI) sequence, to acquire k-space samples along a Cartesian grid or other configuration. The k-space samples are stored in a k-space data buffer 42. A reconstruction processor 44 applies a Fourier transform reconstruction algorithm suitable for reconstructing Cartesian k-space data, or applies another reconstruction algorithm that comports with the spatial encoding used in the k-space data acquisition, in order to generate a reconstructed image that is stored in an image buffer 46. A magnetic susceptibility gradient mapper 50 generates a magnetic susceptibility gradient vector (∇χ) map that is stored in a susceptibility gradient map buffer 52.

With continuing reference to FIG. 1 and with brief reference to FIG. 2, the reconstruction processor 44 and the magnetic susceptibility gradient mapper 50 collectively define a magnetic susceptibility processor 44, 50 that generates a magnetic susceptibility gradient map including directional information from acquired magnetic resonance imaging data. With reference to FIG. 2, an illustrative processing example by the reconstruction processor 44 and by a suitable embodiment of the magnetic susceptibility gradient mapper 50 is described. Acquired magnetic resonance imaging data Dₖ is diagrammatically represented in FIG. 2 by a Cartesian grid of voxels. The magnetic resonance imaging data Dₖ in the illustrated embodiment is k-space data acquired by means of a 2D or 3D gradient echo imaging sequence such as 3D-EPI. The k-space data Dₖ is reconstructed by the reconstruction processor 44 into a complex three-dimensional magnetic resonance image data set D_{I} via suitable image reconstruction techniques such as a Fourier transform reconstruction algorithm.

The magnetic susceptibility gradient mapper 50 extracts a three-dimensional magnetic susceptibility gradient map D_{∇χ} from the complex three-dimensional magnetic resonance image data set D_{I} using one-dimensional Fourier transformations. For each image voxel of the image data set D_{I} (optionally excluding outermost edge voxels), one-dimensional Fourier transforms are computed in each of the three orthogonal Cartesian coordinate directions, such as in each of the three conventional x, y, and z dimensions.

The one-dimensional Fourier transforms are performed for subsets of n adjacent voxels separately in each dimension x, y, and z. In FIG. 2, the determination of a single gradient value in one spatial dimension is shown as an example. The one-dimensional Fourier transform F comprises −n/2 to n/2−1 Fourier components. As can be seen in FIG. 2, the maximum of these Fourier components is shifted proportionally to the local magnetic field gradient acting in the direction of the Fourier transformation. From the discrete Fourier components F, the position of the maximum is determined. Optionally, the position of the maximum is determined at sub-Fourier component resolution by using a least squares fitting procedure. The position of the maximum respective to a zero frequency position of the Fourier components determines a parameter referred to herein as an echo shift parameter SP_{X} for the respective subset of voxels. The same procedure is repeated for the determination of SP_{y} and SP_{z} in the y and z dimensions. The determination of the maxima separately for all three dimensions enables the composition of a vector representing the strength and direction of the magnetic field gradient for the respective subset of voxels.

The magnitudes of these vectors determined for all subsets of n voxels constitute an echo shift map SP. In some embodiments, the echo shift map SP has an n-fold reduced spatial resolution as compared to the three-dimensional magnetic resonance image data set D_{I}. In other contemplated embodiments, the Fourier transforms is performed using a sliding window, and reduces the resolution by an amount smaller than n. Optionally, any resolution lost due to the performing of the Fourier transform is recovered by linear interpolation to generate the three-dimensional magnetic susceptibility gradient map Dᵥₓ with the same resolution as the image D_{I}. Alternatively, the echo shift map SP can serve as the magnetic susceptibility gradient map. In FIG. 2, three-dimensional data sets made up of voxel elements are illustrated—however, acquisition and/or processing of two-dimensional data sets made up of pixel elements is also contemplated.

The illustrated reconstruction processor 44 and magnetic susceptibility gradient mapper 50 are examples. More generally, any suitable technique can be used to generate three-dimensional magnetic susceptibility gradient map D_{∇χ} including susceptibility directional information from acquired magnetic resonance imaging data. For example, another contemplated approach employs specialized magnetic resonance sequences to acquire magnetic resonance imaging data from which appropriate processing can generate the three-dimensional magnetic susceptibility gradient map D_{∇χ} including directional information directly without an intermediate image reconstruction operation. In other contemplated embodiments, the susceptibility gradient map is calculated in the (complex) image-domain, by using a phase map and fitting a linear slope to the phase of adjacent voxels in each direction of space, similar to the FFT in each direction of space. This provides similar information since the echo shift in k-space is reflected in a change in phase in image-space. This approach may entail unwrapping of the phase, especially in 3D, before fitting the linear slope.

With continuing reference to FIG. 1, the three-dimensional magnetic susceptibility gradient map D_{∇χ} is stored in the susceptibility gradient map buffer 52, and is processed by a susceptibility gradient filter 60 to generate a susceptibility gradient image that is stored in a susceptibility gradient image buffer 62. The susceptibility gradient image depicts magnetic susceptibility gradient information including at least some magnetic susceptibility gradient magnitude information and at least some magnetic susceptibility gradient directional information. As disclosed herein, by including at least some magnetic susceptibility gradient directional information in the susceptibility gradient image, the resulting gradient image can be constructed to emphasize contrast corresponding to features of interest while suppressing contrast corresponding to features not of interest. The susceptibility gradient image may be displayed on a display 64 of a user interface 66, or printed on a printer or other marking engine 68, stored on a hard disk or other non-volatile memory, transmitted over a local area network or over the Internet, or otherwise utilized. In the illustrated embodiment, the user interface 66 also enables a physician, researcher, radiologist or other user to interface with the controller 40 to operate the magnetic resonance scanner 10. In other embodiments, separate user interfaces are provided for operating the scanner and for displaying or otherwise utilizing the generated images.

In some embodiments, the susceptibility gradient filter 60 is configured to suppress large-scale magnetic susceptibility gradients, that is, susceptibility gradients that exhibit directional ordering on a relatively large scale. These embodiments are of advantage where the features of interest are expected to be of relatively small scale, such as imaging of labeled cells or of aggregations of labeled cells. In such an application, large-scale magnetic susceptibility gradient directional ordering is likely to be associated with an air/tissue transition or other larger scale anatomical feature not related to the labeled cells. In a suitable approach for suppressing large-scale magnetic susceptibility gradients, the directional ordering of the magnetic susceptibility gradients is determined on a per-pixel or per-voxel basis. If the directional ordering exceeds a threshold value, then the susceptibility gradient is suppressed as a large-scale susceptibility gradient.

With continuing reference to FIG. 1, in some embodiments the susceptibility gradient filter 60 employs a kernel filter. A kernel filter works by applying a kernel 70 to every pixel or voxel in the image (possibly excluding pixels or voxels at the edges of the image). The kernel defines a vector sum or another combination of magnetic susceptibility vectors of at least some pixels or voxels selected from the group consisting of a central pixel or voxel and its neighbors. The central pixel or voxel is replaced with the sum or other combination generated using the kernel. As an example, a normalized vector sum kernel is suitably written as:

$${V}_{x , y , z} ← ‖ \begin{matrix}\begin{matrix}\begin{matrix}\begin{matrix}\begin{matrix}\begin{matrix}\begin{matrix}\begin{matrix}{V}_{x - 1 , y - 1 , z - 1} + {V}_{x - 1 , y - 1 , z} + {V}_{x - 1 , y - 1 , z + 1} + \\ {V}_{x - 1 , y , z - 1} + {V}_{x - 1 , y , z} + {V}_{x - 1 , y , z + 1} +\end{matrix} \\ {V}_{x - 1 , y + 1 , z - 1} + {V}_{x - 1 , y + 1 , z} + {V}_{x - 1 , y + 1 , z + 1} +\end{matrix} \\ {V}_{x , y - 1 , z - 1} + {V}_{x , y - 1 , z} + {V}_{z , y - 1 , z + 1} +\end{matrix} \\ {V}_{x , y , z - 1} + {V}_{x , y , z} + {V}_{x , y , z + 1} +\end{matrix} \\ {V}_{x , y + 1 , z - 1} + {V}_{x , y + 1 , z} + {V}_{x , y + 1 , z + 1} +\end{matrix} \\ {V}_{x + 1 , y - 1 , z - 1} + {V}_{x + 1 , y - 1 , z} + {V}_{x + 1 , y - 1 , z + 1} +\end{matrix} \\ {V}_{x + 1 , y , z - 1} + {V}_{x + 1 , y , z} + {V}_{x + 1 , y , z + 1} +\end{matrix} \\ {V}_{x + 1 , y + 1 , z - 1} + {V}_{x + 1 , y + 1 , z} + {V}_{x + 1 , y + 1 , z + 1}\end{matrix} ‖ \div 27 , \qquad ( 1 )$$

where the voxel V_{x,y,z} is the central voxel, the symbol “←” denotes the replacement operation, and the expression to the right of the “←” symbol denotes the vector sum of the magnetic susceptibility vectors of the voxel V_{x,y,z} and its twenty-six nearest neighbors, that is, the vector sum of the magnetic susceptibility vectors of the twenty-seven voxels in the 3×3×3 cube of voxels centered on the voxel V_{x,y,z}, normalized by the scaling factor 1/27. The symbol ∥·∥ denotes the magnitude of the vector sum.

The magnitude of this vector sum kernel is likely to be large if the susceptibility vector has ordering over a spatial range at least as large as the kernel size, that is, the 3×3×3 cube of voxels, since in that case the susceptibility gradient vectors combined by the kernel of Equation (1) are oriented in the same general direction and will combine to produce a relatively large vector sum. Such is expected to be the case for a magnetic susceptibility gradient generated by air/tissue boundaries and other relatively large-scale features.

On the other hand, a small object such as a biological cell or small group of biological cells marked with an iron oxide-based magnetic contrast agent will produce a magnetic susceptibility gradient that has ordering over a typically small spatial range. In that case, the susceptibility gradient vectors combined by the kernel of Equation (1) are oriented in generally different directions, and will not combine to produce a relatively large vector sum. In other words, while the susceptibility gradient vectors due to the labeled cell or aggregation of labeled cells may have individually large magnitudes, the directions of these susceptibility gradient vectors are substantially randomly oriented, so that the susceptibility gradient vectors tend to cancel out in the vector sum of Equation (1), producing a small value.

The kernel of Equation (1) is an illustrative example, and other kernels can be used. For example, a larger kernel performing a vector sum over the 125 voxels of a 5×5×5 cube can be similarly used. Kernels that perform combinations other than vector sums are also contemplated, such as a kernel that sums only one component of the magnetic susceptibility vectors, e.g. the “x” component.

With reference to FIG. 3, an embodiment of the susceptibility gradient filter is diagrammatically illustrated. The susceptibility gradient map D_{∇χ} is processed on a voxel-by-voxel basis. A voxel selector 80 selects a voxel for filtering. A vector summer 82 computes a vector sum using the selected voxel as the central voxel and performing the vector addition of Equation (1), or in accordance with another selected kernel, and performs additional processing 84 including for Equation (1) computing the magnitude of the vector sum and dividing by N, that is, the number of voxels in the kernel (N=27 for Equation (1), but if for example the kernel is a 5×5×5 cube then N=125 would be more suitable, for example). In some embodiments, the normalization operation “÷N” is omitted. Moreover, the kernel may define operations other than a vector sum. For example, the kernel may approximate a magnitude of a divergence operation (“∥∇·∥”) by an appropriate combination of numerical differentiation operations.

For the illustrated example in which the kernel defines the scaled magnitude of a vector sum, the filtering further includes a thresholding operation. In a suitable approach, a graphical user interface dialog 86 provides the user with a slider 88 that the user can manipulate to select the amount of filtering. As indicated in the graphical user interface dialog 86, a large value of the threshold as input via the slider 88 results in filtering out only the largest features, that is, those features exhibiting the largest long-range directional ordering. Conversely, a small value of the threshold as input via the slider 88 results in filtering out all but the smallest features, that is, those features having very little long-range directional ordering. The illustrated slider 88 is optionally replaced by a numerical input, a discrete set of selections spanning the allowed threshold range, or so forth. The threshold selected using the graphical user interface dialog 86, or selected via another type of user input, or hard-coded into the filter 60, is applied by a thresholder 90. If the filtered value (in the illustrated example, the normalized vector sum magnitude) is below the threshold value, then the indicated long-range directional ordering is low enough that the susceptibility gradient feature likely corresponds to a cell or cell aggregation or other feature of similar size, and so a voxel magnitude transfer block 92 computes the magnitude of the selected voxel (that is, the central voxel of the applied kernel). Alternatively, if the filtered value is at or above the threshold value, then the indicated long-range directional ordering is too high, indicating that the susceptibility gradient feature likely corresponds to an air/tissue boundary or other large-scale feature that is not of interest, and so a voxel replacement block 94 replaces the selected voxel (that is, the central voxel of the applied kernel) with a default low brightness value.

The outputs of the blocks 92, 94 are combined to generate a susceptibility gradient image 96 with both magnitude and directional information. Magnitude information is included in the susceptibility gradient image 96 in that the magnitudes of those susceptibility gradient vectors having only short-range directional ordering are incorporated into the gradient image 96 via the voxel magnitude transfer block 92. Directional information is included in the susceptibility gradient image 96 in that those susceptibility gradient vectors having long-range directional ordering that is “too large” as indicated by the threshold are removed and replaced by the default low-brightness value, so that the susceptibility gradient image 96 retains only susceptibility gradients with short-range ordering compared with the threshold. The susceptibility gradient image 96 is suitably stored in the susceptibility gradient image buffer 62 shown in FIG. 1, and is suitably displayed on the display 64 using grayscale intensity encoding, color coding, or other rendering, or is printed via the marking engine 68 or otherwise utilized.

With reference to FIGS. 4 and 5, and an example of the application of the filtering of FIG. 3 is illustrated. FIG. 4 shows a susceptibility gradient map converted to magnitude values without the filtering shown in FIG. 3. In other words, FIG. 4 shows plots susceptibility gradient magnitude values for a slice of the susceptibility gradient map D_{∇χ}. A feature LC represents an aggregation of cells labeled with an iron oxide-based label. Features AT, on the other hand, represent air/tissue boundaries or interfaces. FIG. 5 shows the susceptibility gradient map of FIG. 4 after filtering in accordance with the method of FIG. 3, using a vector additive 3×3×3 cube of voxels. The labeled cells feature LC remains, while the air/tissue interface features AT are seen to be largely suppressed by the long-range directional filtering.

The illustrated kernel filtering is an illustrative example. The filter 60 can employ other types of filters. For example, the filter 60 can apply a filter including applying a vector field operation to the magnetic susceptibility gradient. For example, one vector field operation that is contemplated as being useful for identifying labeled cells or cell aggregations is the divergence operation. A suitable filter is as follows:

$${D}_{∇ χ}^{F} = ‖ ∇ \cdot {D}_{∇ χ} ‖ = ‖ \frac{{( \partial {D}_{∇ χ} )}_{x}}{\partial x} + \frac{{( \partial {D}_{∇ χ} )}_{y}}{\partial y} + \frac{{( \partial {D}_{∇ χ} )}_{z}}{\partial z} ‖ . \qquad ( 2 )$$

The divergence field operation is an operator that measures the tendency of the field to originate from or converge upon a given point. In the case of a labeled cell or cell aggregation, the susceptibility gradient should originate from or converge at the labeled cell or cell aggregation, and so Equation (2) should have a relatively large value for such regions. On the other hand, an air/tissue interface is more extended and does not have a point source configuration, and so the divergence value is relatively lower. In some embodiments, the output D_{∇χ}^{F} of Equation (2) is thresholded as shown in FIG. 3 to generate the susceptibility gradient image 96 in conjunction with the thresholder 90 and transfer blocks 92, 94. Since a high value of the divergence magnitude filter output D_{∇χ}^{F} of Equation (2) is more likely to correspond to labeled cells whereas a low value is more likely to correspond to air/tissue interfaces or other large-scale directional features, the “<” comparator of the thresholder 90 should be replaced by a “>” comparator when using the filter of Equation (2) in order to selectively retain features having a size and configuration corresponding to labeled cells or cell aggregations.

The filtering approach shown in FIG. 3 transfers susceptibility gradient vector magnitudes into the susceptibility gradient image 96 via the voxel magnitude transfer block 92, except for those values that are replaced by the voxel replacement block 94 as controlled by the thresholder 90. The threshold is selected in the approach of FIG. 3 to generate the susceptibility gradient image depicting magnetic susceptibility gradient magnitude but with magnetic susceptibility gradient magnitude directionally ordered over greater than a selected spatial ordering range suppressed. Such an approach is well-suited for imaging small features such as labeled cells and cell aggregations.

Alternatively, the threshold could be used to generate the susceptibility gradient image depicting magnetic susceptibility gradient magnitude but with magnetic susceptibility gradient magnitude directionally ordered over less than a selected spatial ordering range suppressed. Such an alternative approach is well-suited for imaging larger-scale features such as air/tissue interfaces while suppressing smaller-scale magnetic susceptibility gradient features that are unlikely to correspond to air/tissue interfaces.

The filtering approach shown in FIG. 3 transfers susceptibility gradient vector magnitudes into the susceptibility gradient image 96 via the voxel magnitude transfer block 92, except for those values that are replaced by the voxel replacement block 94 as controlled by the thresholder 90. However, it is also contemplated to directly employ the output of the kernel filter, vector field operation, or other computation, rather than using it as a thresholding mechanism. For example, the output D_{∇χ}^{F} of Equation (2) can directly serve as the magnetic susceptibility gradient image, rather than using this output to control thresholding. In this case, the magnetic susceptibility gradient image is the divergence of the susceptibility gradient map. In this embodiment, the output D_{∇χ}^{F} of Equation (2) is directly stored in the susceptibility gradient image buffer 62 shown in FIG. 1, and is suitably displayed on the display 64 using grayscale intensity encoding, color coding, or other rendering, or is printed via the marking engine 68 or otherwise utilized.

With reference to FIG. 6, another contemplated approach for generating a susceptibility gradient image makes use of directional tracking of the magnetic susceptibility gradient vectors. For example, the susceptibility gradient map D_{∇χ} is displayed on the display 64 of the graphical user interface 66, for example as selected slices plotting susceptibility gradient vector magnitude in grayscale. The user selects a seed voxel 100 for tracking, or an aggregation of such seed voxels. The susceptibility gradient direction is determined at the current voxel, and the susceptibility gradient flow is iteratively tracked by following the direction of the magnetic susceptibility gradient vectors from voxel to voxel. In FIG. 6, a susceptibility gradient direction processor 102 determines the susceptibility direction at the current voxel. To accommodate noise, the direction can be determined using an average direction of the current voxel and its nearest neighbors, or by using some other directional averaging or smoothing. Optionally, the determined direction can be projected onto a plane of interest, such as a selected slice plane that is to be displayed with the susceptibility gradient flow superimposed thereon. A current voxel direction labeler 104 labels the current voxel with the determined direction, and a next voxel identifier 106 identifies the next voxel along the determined direction. Again, the next voxel is optionally constrained to lie within a plane of interest. A stopping criterion decision block 108 determines whether the susceptibility gradient flow has terminated (for example, if the susceptibility gradient is too small to effectively follow) and if not processing loops back to the susceptibility gradient direction processor 102 to process the next voxel. The result of such processing is a susceptibility gradient flow line 110 starting at the seed voxel 100 and terminating at a point determined by the stopping criterion decision block 108. Optionally, tracking can be initiated from each of a plurality of different seed voxels, such as a line or surface of voxels, and the results combined to produce a set of flow lines mapping the susceptibility gradient directional flow.

Such a tracking approach is expected to be useful when the source of the magnetic susceptibility gradient has long-range ordering corresponding to a flow. For example, an iron oxide-based magnetic contrast agent injected into the bloodstream can produce inflow of contrast agent into an organ of interest that can be tracked using the contemplated directional tracking approach. By acquiring successive images at different times during the influx of contrast agent into the organ of interest, the inflow can be accurately mapped over time, and features such as blood flow blockages identified. The resulting flow lines can be superimposed on the reconstructed image, or on the a magnitude image of the susceptibility gradient map D_{∇χ}. More complex representations, for example in which the displayed flow line has a width at each point along the flow line corresponding to the magnitude of the susceptibility gradient vector at that point, are also contemplated.

With reference back to FIG. 1, the disclosed processing components, such as the illustrated reconstruction processor 44, susceptibility gradient mapper 50, and susceptibility gradient filter 60, 70 can be physically implemented in various ways. In some embodiments, the components are implemented by a general purpose processor such as a microprocessor, microcontroller, or combination of microprocessors or microcontrollers in conjunction with a storage medium or media that stores instructions executable to perform selected methods implemented by the illustrated processing components 44, 50, 60, 70. The storage medium may be a non-volatile memory or storage such as an optical disk, magnetic disk, magnetic tape, FLASH memory, network server memory, or so forth, a volatile storage or memory such as random access memory (RAM), or various combinations thereof. In some embodiments, one, some, or all of the processing components 44, 50, 60, 70 are implemented as application specific integrated circuitry (ASIC) components. In some embodiments, one, some, or all of the processing components 44, 50, 60, 70 are integrated with the graphical user interface 66. For example, the graphical user interface 66 may be a computer with a hard drive or other storage medium storing instructions executable by one or more processors of the computer to perform selected methods implemented by the illustrated processing components 44, 50, 60, 70, with the graphical user interface implemented by additional stored instructions executable by the one or more processors in conjunction with the display 64 and keyboard, mouse, or other user input devices. The various processing components 44, 50, 60, 70 may be partially or wholly integrated in various ways, for example a single computer separate from the graphical user interface 66 may embody the processing components 44, 50, 60, 70. In some such latter embodiments, the computer embodying the processing components 44, 50, 60, 70 may be logically disposed on a network or the Internet and accessible using a computer defining the graphical user interface 66 that is disposed with the magnetic resonance scanner 10. These are merely some illustrative implementations, and the processing components 44, 50, 60, 70 can be implemented as other configurations of hardware, software, firmware or various combinations thereof.

The preferred embodiments have been described. Modifications and alterations may occur to others upon reading and understanding the preceding detailed description. It is intended that the invention be construed as including all such modifications and alterations insofar as they come within the scope of the appended claims or the equivalents thereof.

1. A method comprising:
acquiring magnetic resonance imaging data;
generating a magnetic susceptibility gradient vector map from the magnetic resonance imaging data; and
filtering the magnetic susceptibility gradient vector map to generate a magnetic susceptibility gradient image depicting magnetic susceptibility gradient information including at least some magnetic susceptibility gradient directional information.

2. The method as set forth in claim 1, further comprising:
displaying the magnetic susceptibility gradient image.

3. The method as set forth in claim 1, wherein the generating comprises:
reconstructing a magnetic resonance image from the acquired magnetic resonance imaging data; and
computing magnetic susceptibility gradient vectors having components derived from orthogonal one-dimensional Fourier transforms of linearly contiguous pixels or voxels of the magnetic resonance image.

4. The method as set forth in claim 1, wherein the generating comprises:
deriving magnetic susceptibility gradient vectors from magnetic susceptibility gradient-induced echo shifts extracted from the magnetic resonance imaging data.

5. The method as set forth in claim 1, wherein the filtering comprises:
applying a kernel filter to the magnetic susceptibility gradient vector map a kernel of the kernel filter combining magnetic susceptibility gradient vectors of at least some pixels or voxels selected from a group consisting of a central pixel or voxel and its neighbors.

6. The method as set forth in claim 5, wherein the kernel generates a vector sum of the magnetic susceptibility gradient vectors of the selected pixels or voxels.

7. The method as set forth in claim 1, wherein the filtering comprises:
applying a vector field operation at least partially operative on the vector field direction to the magnetic susceptibility gradient vector map.

8. The method as set forth in claim 7, wherein the vector field operation includes a divergence operation.

9. The method as set forth in claim 1, wherein the filtering comprises:
generating a magnetic susceptibility gradient image depicting magnetic susceptibility gradient magnitude and with suppression of magnetic susceptibility gradient magnitude that is directionally ordered over greater than a selected spatial ordering range.

10. The method as set forth in claim 1, wherein the filtering comprises:
tracking susceptibility gradient flow in the magnetic susceptibility gradient vector map to generate one or more magnetic susceptibility gradient vector flow lines.

11. A processor or computer medium programmed to perform a method as set forth in claim 1.

12. An apparatus comprising:
a magnetic susceptibility gradient processor configured to generate a magnetic susceptibility gradient vector map from magnetic resonance imaging data; and
a susceptibility gradient filter configured to filter the magnetic susceptibility gradient vector map to generate a magnetic susceptibility gradient image depicting magnetic susceptibility gradient information including at least some magnetic susceptibility gradient directional information.

13. The apparatus as set forth in claim 12, further comprising:
a magnetic resonance scanner configured to acquire magnetic resonance imaging data.

14. The apparatus as set forth in claim 12, further comprising:
an display or marking engine configured to display or print the magnetic susceptibility gradient image.

15. The apparatus as set forth in claim 12, wherein the magnetic susceptibility gradient processor comprises:
a reconstruction processor configured to reconstruct a magnetic resonance image from the acquired magnetic resonance imaging data; and
a magnetic susceptibility mapper configured to compute magnetic susceptibility gradient vectors based on magnetic susceptibility gradient-induced echo shifts extracted from the magnetic resonance image.

16. The apparatus as set forth in claim 12, wherein the susceptibility gradient filter comprises:
a kernel filter having a kernel that combines magnetic susceptibility gradient vectors of at least some pixels or voxels selected from the group consisting of a central pixel or voxel and its neighbors.

17. The apparatus as set forth in claim 12, wherein the susceptibility gradient filter comprises:
a vector summer configured to additively combine the magnetic susceptibility vectors of the selected pixels or voxels.

18. The apparatus as set forth in claim 12, wherein the susceptibility gradient filter applies a vector field operator to the magnetic susceptibility gradient vector map.

19. The apparatus as set forth in claim 12, wherein the susceptibility gradient filter comprises:
a flow tracker configured to track susceptibility gradient flow in the magnetic susceptibility gradient vector map to generate one or more magnetic susceptibility gradient vector flow lines.

20. A storage medium storing instructions executable to perform a method comprising:
generating a magnetic susceptibility gradient vector map from magnetic resonance imaging data; and
filtering the magnetic susceptibility gradient vector map to generate a magnetic susceptibility gradient image depicting magnetic susceptibility gradient information including at least some magnetic susceptibility gradient directional information.

21. The storage medium as set forth in claim 20, wherein the filtering comprises one of:
applying a kernel filter to the magnetic susceptibility gradient vector map;
applying a vector field operation to the magnetic susceptibility gradient vector map; and
tracking susceptibility gradient flow in the magnetic susceptibility gradient vector map to generate one or more magnetic susceptibility gradient vector flow lines.
